(19) United States
(12) Patent Application Publication
(10) Pub. No.: US 2020/0005367 A1
(43) Pub. Date: Jan. 2, 2020

(54) Real-Time Video Call Application for Buyers and Sellers

(71) Applicants: IKECHUKWU CHRISTIAN-EZEOFOR, Hillsboro, OR (US); Idongesit Umoette, Missouri City, TX (US)

(72) Inventors: IKECHUKWU CHRISTIAN-EZEOFOR, Hillsboro, OR (US); Idongesit Umoette, Missouri City, TX (US)

(21) Appl. No.: 16/020,349

(22) Filed: Jun. 27, 2018

(51) Int. Cl. G06Q 30/06; H04N 7/14; G06Q 30/00; G06Q 20/40

(52) U.S. Cl. CPC G06Q 30/0601; G06Q 20/4012; G06Q 30/018; H04N 7/141

(57) ABSTRACT

This Invention includes unique Ecommerce application features. The features include a Real-Time Video Call between buyers and sellers. Live Stream feature that enables sellers showcase their products and services in a live video with the public. An Online Appointment Setup feature for Video Call to enable sellers choose when to be reached for a video call by buyers. Transportation Category that solves everyday Ecommerce logistic issue with transporting large items. Accountability Feature for missed physical meet-ups. Pin Code System feature for Physical Appointments to ensure smooth and safe transactions for both buyers and sellers and for accurate tracking of all successful transactions initialed from the Ecommerce application.

### BACKGROUND OF THE INVENTION

With services such as Amazon, OfferUp, Letgo, Craigslist, and eBay, it's easier than ever to order millions of products online to be shipped to a doorstep. While the process of ordering is facilitated, the process of checking for functionality and quality can be much harder. At times, the product arrives only to be damaged or not what was advertised. The present invention looks to introduce a method for an application that enables the seller and buyer to communicate through a real-time video call to confirm the product's functionality and quality before buying the product.

This non-provisional patent application is a continuation of the expired Provisional Patent Application No. 62/459,725 (Electronic Filing System ID 28376246) with the title, SketchSale.

### BRIEF SUMMARY OF THE INVENTION

### Feature1: Real-Time Video Call

This enables a seller to video call a buyer and inquire more about a product's functionality and quality before making a purchase. Buyers can also be able to effectively negotiate and close a deal faster than a regular text chatting option. This invention gives customers the peace of mind needed in today's ecommerce industry and helps eliminate online scams. This feature also brings people together socially while doing online business.

### Feature2: Ecommerce Live Stream

This feature enables sellers to live stream their products, showcase their services and skills, magic shows, and more to their audience. It is the connectivity of the ecommerce industry between sellers and buyers. Making it more attractive and gives sellers the same benefit of having a physical location where they can showcase their skills and services. Sellers can now reach audience far away and be able to close a deal and sell their services to customers online at the same time servicing audience in their physical location.

### Feature3: Online Appointment Setup for Video Call

This feature enables sellers to have some privacy and be able to choose when a buyer can contact them. This is like having a physical store with hours of operation. Sellers can set the video call button to be active only during a specific period on the day for customers to contact them or choose to have customers message them for a video call appointment, just like customers can book an appointment to a physical business location.

### Feature4: Transportation Category

This feature enables a user with pickup trucks, van, or other large vehicles to offer to transport any item purchased on the platform for a buyer or seller at a competitive price within the city. This will help buyers find affordable items and have a means to ship it at a very low cost. This will also help every day sellers sell their large items faster as buyers now have a means to transport them at a low cost. In the past, a seller selling a used/new piece of large furniture takes months to sell the item because buyers do not have a means to transport the product at an affordable price if they purchase it. This feature will eliminate the barriers for both sellers and buyers.

### Feature5: Accountability Feature

Buyers and sellers have grown frustration in the ecommerce business for missed appointments without prior notification or after notification. Sellers book an appointment to meet with a seller and won't show up without cancelling. Most times this happens multiple times with the same buyer booking and failing to show up to an appointment, whereas the seller reserves his times, cancel appointments, and most times drive miles to a public location to meet with the buyer who won't show up. This feature works to reduce or eliminate this waste of time and money on either party. If a buyer and seller agree to meet and didn't cancel the appointment at least an hour prior to the meeting, and then didn't show up, the party that didn't show up will be charged a $5 fee payable to the party that showed up. This way, both the buyer and seller will be more inclined to make appointments or won't book one if they know they won't be available or give ample time for the other party to go ahead and make other plans.

### Feature6: Pin Code System for Physical Transactions

This is a feature to ensure a successful transaction between buyers and sellers in the case they finalized a transaction during a physical meet up. Also, this feature enables tracking of all successful transaction that initiated through our application in the case the transaction was closed outside the application. When a buyer and seller decide to meet to finalize a transaction for any reason, the buyer and seller will each be given a 2 unique 4-6-digit code to exchange with each other at the end of the transaction to indicate the transaction was successful and final. Each party will be able to input the code in the app to indicate the transaction was successful. One of the code will be a code to indicate the transaction was successful and the other will indicate an alarm. Each party will be able to confirm if the code is an actual code from the application but won't be able to confirm if it is a successful transaction code or an alarm code until after an hour of inputting the code. This will help eliminate buyers or sellers being robbed at gun point for their product or money.

This summary is provided merely for the purposes of summarizing some example embodiments, to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF DRAWING

FIG. 1: “Live Now” Icon showing at the top right corner of the of app's home screen. This button takes you to the live video home screen.

FIG. 2: Live Now home screen. Displays all the live videos

FIG. 3: Live video screen. This screen appears after a user clicks on a video on the Live Now home screen. From this screen they can see the active live video, chat with the seller, and be able to purchase their product or services.

FIG. 4: This screen shows the “Video Call” icon at the top right corner of the seller's name. Also displaying their available times. When this icon is active, a user can video call the seller on the screen.

FIG. 5: From this screen, a seller can change their availability window to be reached by buyers

FIG. 6: This screen shows the “Pin Code System” generation when a seller and buyer decides to meet physically to complete their transaction.

FIG. 7: This screen displays the “Transportation Category” section of the app.

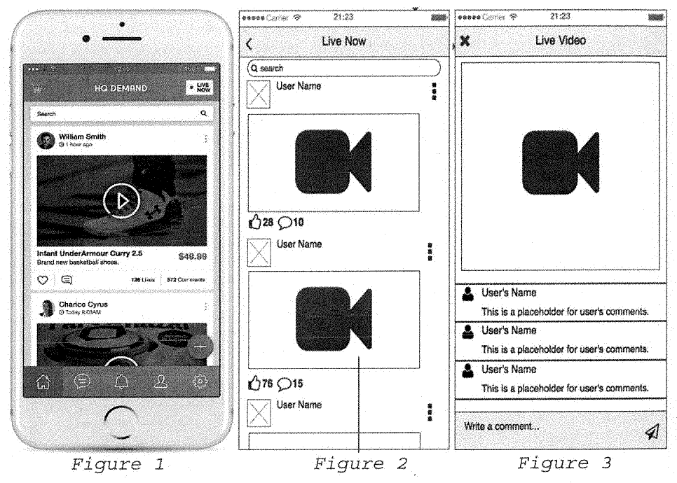

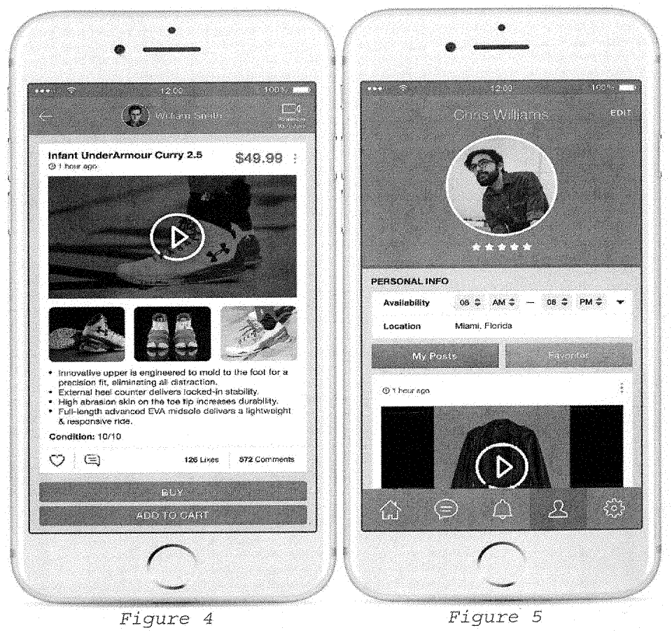

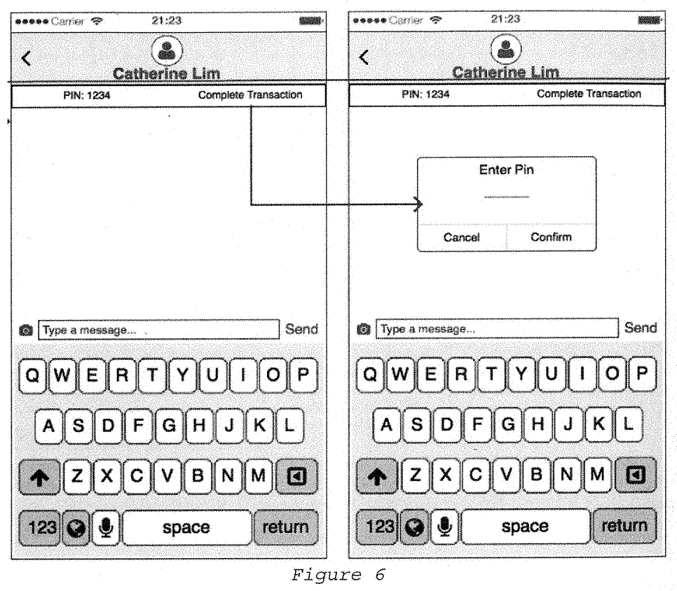

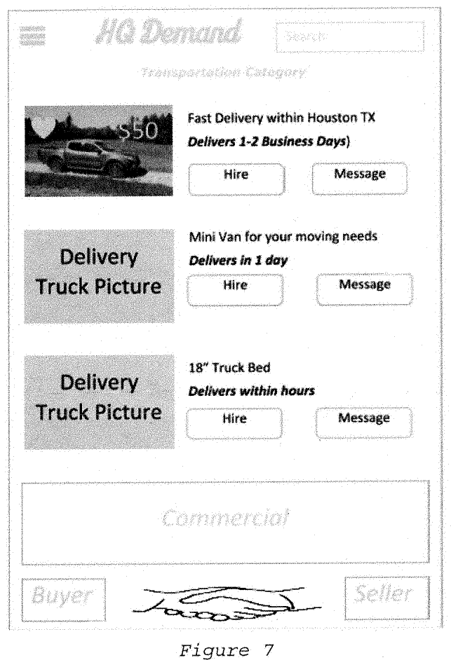

### DETAILED DESCRIPTION OF THE INVENTION

Detailed descriptions of the preferred embodiment are provided herein. It is to be understood. However, that the present invention May be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

### Feature1: Real-Time Video Call

This feature will appear as a button next to a seller's profile. A buyer can click the button and video chat with the seller inside the app using their phone camera. A seller uploads a video and pictures of a product he/she wishes to sell. During the upload, the seller specifies an availability window whereby buyers that are interested in the product can video call the seller to confirm the quality and functionality of the listed product before purchasing it. Sellers can also specify to have buyers message them first for a video call appointment. When the seller and buyer reach an appointment window agreement, the seller can activate his/her video call button specifically for the buyer to call only within the agreed time frame. After the buyer confirms the product and is ready to buy, he/she can then add it to their cart and purchase it.

### Feature2: Ecommerce Live Stream

Sellers can go live on the app showcasing their services and products. Buyers can view, live chat, and purchase services and products from the seller during the live stream. The public will be able to see all the live chats and activities during and after the live chat. If a buyer purchases a product or service from the live chat, they will finish the purchase through a message communication or cart transaction.

### Feature3: Online Appointment Setup for Video Call

Sellers will be able to set up an appointment window for the video call for buyers to contact them within their profile. Just like physical businesses have business hours. They will also be able to choose to be messaged before a video call as an option. During the seller's set video call window, the video call button will be active, and buyers can click it video call. It will be inactive during any other times and buyers won't be able to video call them. If the seller chooses to be contacted in a message first before they can video chat with a buyer, then the video call button will be inactive. It will only be activated by the during the set appointment window between the buyer and seller.

### Feature4: Transportation Category

In the transportation category, a seller who has a truck or van and can transport bigger items like furniture can list their truck/van in this category and give an estimate of how long it will take them to transport a product, say 1-2 business days if hired. A user will be able to find someone who can transport their purchased product around their zip code.

### Feature5: Accountability Feature

Once a buyer and seller agree to meet physically and sets an appointment through the application, they have up to an hour before the set appointment to cancel or be charged a no-show fee of $5 if they don't cancel an hour prior to the appointment window. A user will be required to set up their payment option before setting an appointment using the application.
   Feature6: Pin Code System for physical transactions
2 unique 4-6-digit codes will be generated for a buyer and seller each time they set up a physical appointment through the application. One of the codes will indicate a “successful transaction” and the other will indicate an “alarm”. When the codes are exchanged between the parties and inputted in the application, they will be notified if the code the inputted was one of the codes generated by the application for that transaction. However, they won't be able to confirm if it is the “successful transaction” code or the “alarm” code until an hour after it has been inputted. This is to ensure each party is not forced to give their codes to finalize a false transaction and to give each party ample time to get home safety or have the alarm reported to the police for investigation.

While a specific embodiment has been shown and described, many variations are possible. With time, additional features may be employed. The shape or configuration of the platform or the interior configuration may be changed to suit the system or equipment with which it is used.

Having described the invention in detail, rose skilled in the art will appreciate that modifications may be made to the invention without departing from its spirit. There for, it is not intended that the scope of the invention be limited to the specific embodiment illustrated and described. Rather, is intended that the scope of this invention be determined by the appended claims and their equivalents.

The abstract of the Discloser is provided to allow the reader to quickly ascertain the nature of the technical discloser. It is submitted with the understand that it will not be used to interpret or limit the scope for meaning of the claims. In addition, in the foregoing Detailed Description, various features are grouped together in various embodiments for streamlining the disclosure. This method of discloser is not to be interpreted as reflecting an intention that the claimed embodiments require more features than are expressly recited in each claim. Rather, as the following claims reflect, incentive subject matter lies in less than all features of a single disclosed embodiment. Thus, the following claims are hereby incorporated into the Detailed Description, with each claim standing on its own as a separately claimed subject matter.

I. A method of communicating with a seller through a real-time video call, wherein the method comprises:
A clickable video call button in an Ecommerce shopping app/website;
A means for a seller and buyer to virtually communicate in real-time;
A means for a sellers and buyer to see each other in the same shopping platform;
A means for sellers to setup a time period for the said video call;
Ability to make the video call button active during a selected time period or inactive otherwise;
A means where by the video call hours are displaced around the video call button;
Whereby sellers and buyers can negotiate, verify products/services, and finalize transactions through real-time video call in the app/website platform without having to physically meet.

II. A method for sellers to showcase products, services, and skills through Live Streaming in the platform, wherein the method comprises:
A means for sellers to connect with shoppers in live video in an Ecommerce platform;
A means for a seller to showcase products, skills and services to a large audience in an Ecommerce platform;
A means for buyers to chat in this said live streaming;
A means for buyers to purchase a product or service in this live streaming platform;
A means for buyers to like and comment on the product or services in the live streaming;
Whereby the seller and buyers can do business or showcase their products and services without having to physically meet.

III. A method for logistical transportation of goods between user-to-user in an Ecommerce app/website, wherein the method comprises:
A means for users to list vehicles for transporting goods;
A means for users to list vehicles at a competitive price within a location;
A means for users to specify the time period it will take to deliver a product if hired;
A means to locate such user within a certain area;
A means to share link for the goods to be transported in the same platform;
A means for a buyer to connect a transporter to a seller;
Whereby, buyers can buy affordable new/used products in an Ecommerce shopping platform and find a means to transport the product at a competitive price within the same platform.

IV. A method to eliminate waste of time and resources for sellers and buyers who set up physical appointments and to ensure safe transactions using an accountability feature and pin code generation, wherein the method comprises:
A means for buyers and sellers to set up a time to meet physically through the platform;
A means requiring both seller and buyer agreeing to meet to update form of payment in the platform;
A means allowing to charge either the seller or buyer a fee if they miss an appointment without prior cancellation within a certain time period;
A means to confirm both seller and buyer made their appointment at the agreed time period;
A means to generate pin codes for both seller and buyer for the physical meetup;
A means for the seller and buyer to verify if the pin code was generated from the Ecommerce platform when each party share their codes;
A means to confirm if given pin code shows the transaction was successful or pin code calls for an alert;
A means to alert police if said pin calls for alert;
Whereby both sellers and buyers are guaranteed that their time/resources won't be wasted when an appointment is book and that business will be conducted safely.
